(19) United States
(12) Patent Application Publication
(10) Pub. No.: US 2004/0233792 A1
(43) Pub. Date: Nov. 25, 2004

(54) Analog clock

(75) Inventor: David Andrew Alleway, Aurora (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Evertz Microsystems Ltd., Burlington (CA)

(21) Appl. No.: 10/406,559

(22) Filed: Apr. 4, 2003

(51) Int. Cl. G06F 1/04; G04F 5/00

(52) U.S. Cl. 368/157

(57) ABSTRACT

A clock is described having an hour hand and a first stepper motor with a first rotor for rotating the hour hand, the first rotor being rigidly connected to the hour hand. The clock also includes a minute hand and a second stepper motor with a second rotor for rotating the minute hand, the second rotor being rigidly connected to the minute hand. A controller controls the first and second stepper motors. A second hand can also be included.

### FIELD OF THE INVENTION

The invention relates to analog clocks.

### BACKGROUND OF THE INVENTION

There are many circumstances where an accurate clock is needed. One example is in the media industry. For instance, in a newsroom, a reliable clock is helpful for the production and broadcast of news programs. In such circumstances, large analog clocks with hands and a face that can be easily read are desirable. Unfortunately, such analog clocks are typically not very accurate, and have many moving parts that can break down.

### SUMMARY OF THE INVENTION

The present invention addresses the aforementioned problems by providing an accurate clock comprised of as few moving parts as there are hands, i.e., two or three. The clock is gearless and can be calibrated and adjusted by a controller. Moreover, in one embodiment of the invention disclosed, the clock can be set with independent motion of the hands in less than ten seconds.

In particular, a clock is described herein that includes an hour hand, and a first stepper motor having a first rotor for rotating the hour hand. The first rotor is rigidly connected to the hour hand. The clock also includes a minute hand, and a second stepper motor having a second rotor for rotating the minute hand. The second rotor is rigidly connected to the minute hand. The clock further includes a controller for controlling the first stepper motor and the second stepper motor.

Also described herein is a clock that includes an hour hand and a first stepper motor for rotating the hour hand. The first stepper motor has a coil wound about an axis and a rotor that rotates about the axis. The coil is disposed inside the rotor. The clock also includes a minute hand and a second stepper motor for rotating the minute hand. The clock further includes a controller for controlling the first stepper motor and the second stepper motor.

In addition, a clock is described herein that includes an hour hand, a minute hand and a second hand. The clock also includes a first stepper motor, a second stepper motor and a third stepper motor for stepping the hour hand, the minute hand and the second hand, respectively. The clock further includes a controller for controlling the first stepper motor, the second stepper motor and the third stepper motor, and a compensation table including two sets of data. The first set has position data of the second hand, and the second set has associated position correction data of the second hand. The controller uses the compensation table for correcting errors in the stepping of the third stepper motor.

A method for rotating the hands of a clock is also described herein that includes rotating an hour hand of the clock with a first rotor of a first stepper motor, the first rotor being rigidly connected to the hour hand. The method also includes rotating a minute hand of the clock with a second rotor of a second stepper motor, the second rotor being rigidly connected to the minute hand. The method further includes controlling the first stepper motor and the second stepper motor with a controller.

Described herein is also a method for manufacturing a clock. The method includes providing a first stepper motor for rotating the hour hand. The first stepper motor has a coil wound about an axis and a rotor that rotates about the axis. The coil is disposed inside the rotor. The method also includes providing a second stepper motor for rotating the minute hand, and providing a controller for controlling the first stepper motor and the second stepper motor.

Further described herein is a method of correcting errors in a clock. The method includes stepping an hour hand, a minute hand and a second hand with a first stepper motor, a second stepper motor and a third stepper motor, respectively. The method further includes correcting errors in the stepping of the third stepper motor with a compensation table that includes two sets of data. The first set has position data of the second hand, and the second set has associated position correction data of the second hand.

### BRIEF DESCRIPTION OF THE DRAWINGS

FIG. 1 shows a block diagram of a clock according to the teachings of the present invention.

FIG. 2 shows the third stepper motor of the clock shown in FIG. 1.

FIG. 3 shows the third rotor of the third stepper motor of FIG. 2.

FIG. 4 shows the stepper motors of the clock of FIG. 1.

FIG. 5 shows the controller of the clock of FIG. 1.

FIG. 6 shows the compensation module of the controller of FIG. 5.

FIGS. 7A and 7B show two plots illustrating errors associated with a stepper motor of the clock of FIG. 1.

FIG. 8 shows the starting mode module 104 of the controller of FIG. 5.

FIG. 9 shows the regular mode module of the controller of FIG. 5.

### DETAILED DESCRIPTION OF THE INVENTION

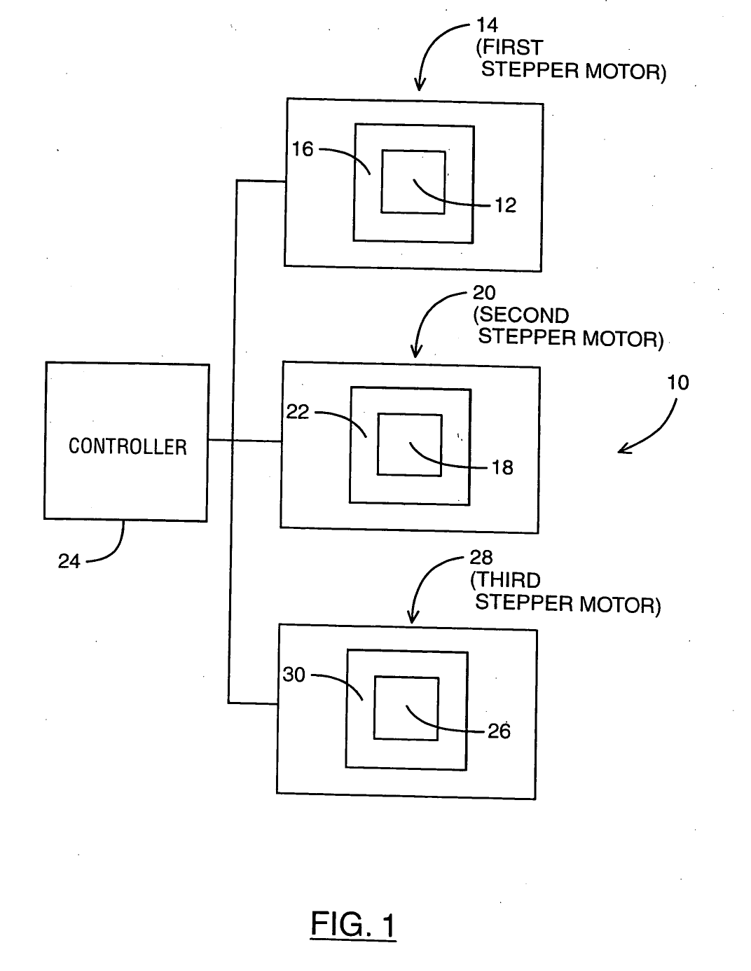

FIG. 1 shows a block diagram of a clock 10 according to the teachings of the present invention. The clock 10 includes an hour hand 12 and a first stepper motor 14 having a first rotor 16 rigidly connected to the hour hand 12. The clock 10 also includes a minute hand 18 and a second stepper motor 20 having a second rotor 22 rigidly connected to the minute hand 18. The clock 10 further includes a controller 24.

Optionally, the clock 10 may include a second hand 26 and a third stepper motor 28 having a third rotor 30 rigidly connected to the second hand 26.

The hour hand 12, the minute hand 18, and the second hand 26 of the clock 10 provide the time of day by indicating the hour, the minute, and the second, respectively. The first rotor 16 of the first stepper motor 14 rotates the hour hand 12. Likewise, the second rotor 22 of the second stepper motor 20 rotates the minute hand 18, and the third stepper motor 28 rotates the second hand 26. The controller 24 controls the first stepper motor 14, the second stepper motor 20 and the third stepper motor 28, as will hereinafter be explained.

The first rotor 16, the second rotor 22 and the third rotor 30 are rigidly connected to the hour hand 12, the minute hand 18 and the second hand 26, respectively. That the first rotor 16 is rigidly connected to the hour hand 12 implies that if the first rotor 16 rotates by an angle about its rotation axis, then the hour hand 12 also rotates by this same angle about this axis. In particular, the first rotor 16 is connected to the hour hand 12 without gears. Similarly, the minute hand 18 and the second hand 26 are rigidly connected to the second rotor 22 and to the third rotor 30, respectively, without gears.

In addition, the hour hand 12, the minute hand 18, and the second hand 26 can be rotated independently with appropriate controller 24 instructions. The controller 24 is described in more detail below.

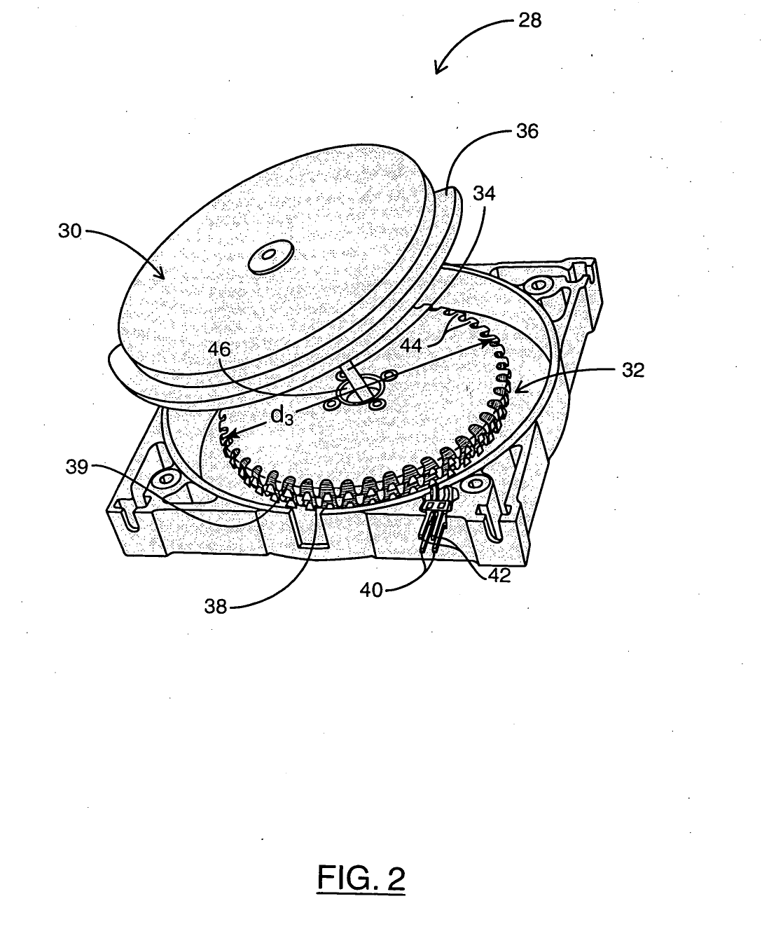

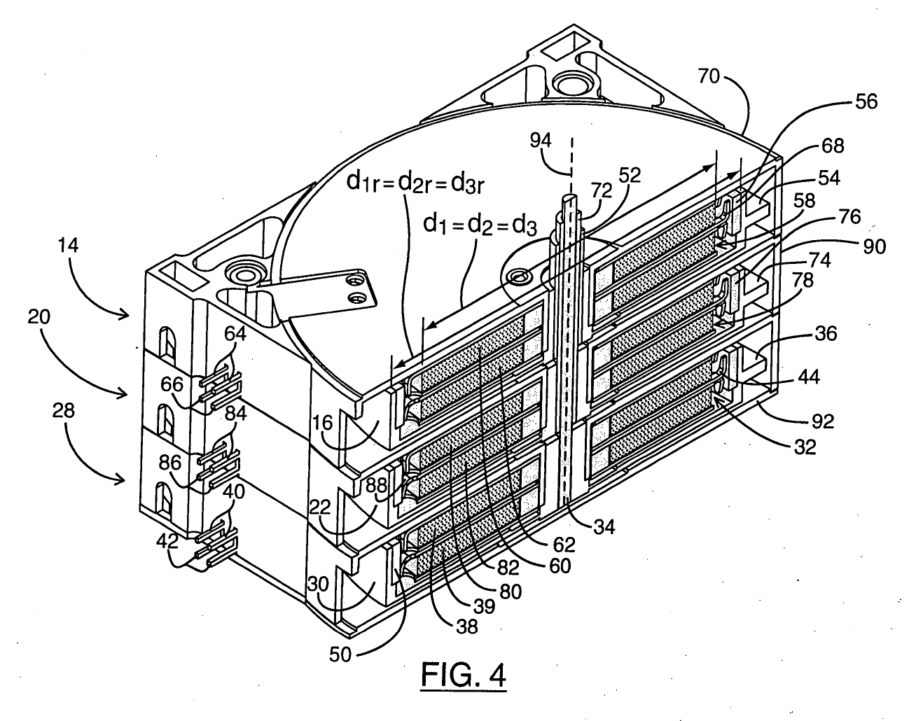

FIG. 2 shows the third stepper motor 28 of the clock 10 shown in FIG. 1. The first stepper motor 14 and the second stepper motor 20 possess similarities to the third stepper motor 28; differences between the three motors are described with reference to FIG. 4 below. The third stepper motor 28 includes a third rotor 30 and a third stator 32. The third rotor 30 includes a third shaft 34 and a third flange 36. The third stator 32 includes two second-hand coils 38, 39 of diameter d₃ having two-second-hand lead pairs 40 and 42. The third stator 32 further includes second-hand stator fingers 44, and a third stator bearing 46.

The third rotor 30 rotates the second hand 26 (not shown in FIG. 2) of the clock 10 via the third shaft 34, which is rigidly attached to the second hand 26. The third flange 36 is disposed along half of the circumference of the third rotor 30. The third flange 36 is on the opposite side of the second hand 26, and acts as a counterweight to the second hand 26. The third flange 36 also interrupts a light beam (not shown in FIG. 2) that, as described in more detail below, is used to correct the position of the second hand 26.

The second-hand lead pair 40 includes one lead for injecting current into the second-hand coil 38 and a second lead for withdrawing current from the second-hand coil 38. Likewise, the second-hand lead pair 42 includes one lead for injecting current into the second-hand coil 39 and a second lead for withdrawing current from the second-hand coil 39. The two second-hand coils 38 and 39 form part of two separate electrical circuits. When current flows through the two second-hand coils 38 and 39, a magnetic field is produced. This field is perturbed by the stator fingers 44, as known to those of ordinary skill. This magnetic field attracts a permanent magnet (not shown in FIG. 2) in the third rotor 30 causing the third rotor 30 to rotate. The third stator bearing 46 facilitates this rotation. Drive voltages applied to the two coils allow the third rotor 30 to rotate in discrete steps, which allow fine positioning of the motor.

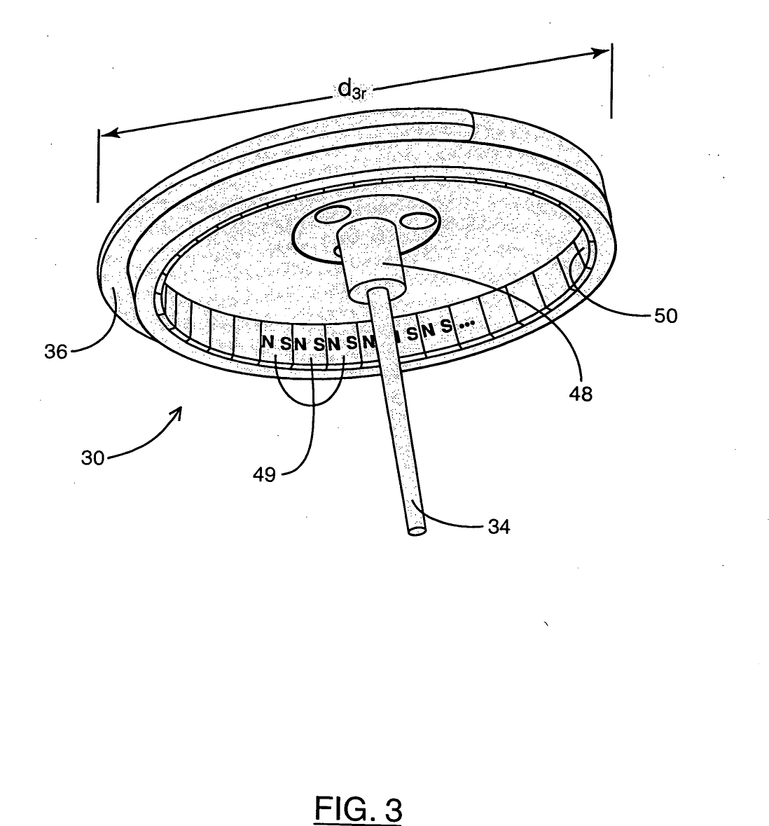

FIG. 3 shows the third rotor 30 of the third stepper motor 28 of FIG. 2. The third rotor 30 includes the third shaft 34, the third flange 36, a third rotor bearing 48, and a third permanent magnet consisting of a circular magnetic strip 50, that is disposed around the inner perimeter of the third rotor 30. The diameter d₃ᵣ of the circular magnetic strip is greater than the diameter d₃ of the second hand coils 38, 39. In one embodiment, the permanent magnet has forty-five pairs of N/S magnetic poles 49, for a total of ninety poles, around the circular magnetic strip 50. Only three such pairs of N/S magnetic poles 49 are shown in FIG. 3.

When current flows through the two second-hand coils 38 and 39, a magnetic field is produced. This magnetic field attracts the forty-five pairs of N/S poles 49 in the third circular magnetic strip 50 in the third rotor 30 causing the third rotor 30 to rotate, which rotation is facilitated by the third rotor bearing 48.

FIGS. 2 and 3 show details of the third stepper motor 28. The first stepper motor 14 and the second stepper motor 20 are similar to the third stepper motor 28, although the three stepper motors 14, 20 and 28 do possess some dissimilarities, some of which are outlined below with reference to FIG. 4.

FIG. 4 shows the stepper motors 14, 20 and 28 of the clock 10 of FIG. 1. The first stepper motor 14 includes a first rotor 16 having a first shaft 52, a first flange 54 and a first circular magnetic strip 56. The first stepper motor 14 also includes a first stator 58 having two hour-hand coils 60 and 62, two hour-hand lead pairs 64 and 66, and hour-hand stator fingers 68. The first stepper motor 14 also includes a first chassis 70.

The second stepper motor 20 includes a second rotor 22 having a second shaft 72, a second flange 74 and a second circular magnetic strip 76. The second stepper motor 20 also includes a second stator 78 having two minute-hand coils 80 and 82, two minute-hand lead pairs 84 and 86, and minute-hand stator fingers 88. The first stepper motor 14 also includes a second chassis 90. A cover 92 encloses the stepper motors 14, 20 and 28.

The first shaft 52 and the second shaft 72 are hollow. The third shaft can be solid or hollow. The third shaft 34 is disposed within the second shaft 72, which is disposed within the first shaft 52. The first shaft 52, the second shaft 72 and the third shaft 34 are cylindrical with a common axis 94. More generally, at least two of the first shaft 52, the second shaft 72 and the third shaft 34 are hollow, and the first shaft 52, the second shaft 72 and the third shaft 34 are concentrically nested.

The first stator 58 of the first stepper motor 14 has two hour-hand coils 60 and 62 wound about the common axis 94. The second stator 78 of the second stepper motor 20 has two minute-hand coils 80 and 82 wound about the common axis 94, and the third stepper motor 28 includes a third stator 32 having two second-hand coils 38 and 39 wound about the common axis 94.

For the embodiment illustrated, the hour-hand coils 60 and 62 are stacked on top of the minute-hand coils 80 and 82, which are stacked on top of the second-hand coils 38 and 39. Other stacking orders may be possible. The first rotor 16, the second rotor 22 and the third rotor 30 rotate about the common axis 94. Likewise, the first rotor 16 is stacked on top of the second rotor 22, which is stacked on top of the third rotor 30.

The first rotor 16 includes a first permanent magnet in the form of a first circular magnetic strip 56 disposed on the inner perimeter of the first rotor 16, the second rotor 22 includes a second magnetic strip 76 disposed on the inner perimeter of the second rotor 22, and the third rotor 30 includes a third magnetic strip permanent magnet 50 disposed on the inner perimeter of the third rotor 30. The two hour-hand coils 60 and 62 are wound circularly with diameter d₁, and the first circular magnetic strip 56 has a diameter d₁ᵣ that is greater than d₁. Likewise, the two minute-hand coils 80 and 82 are wound circularly with diameter d₂, and the second circular magnetic strip 76 has a diameter d₂ᵣ that is greater than d₂. The two second-hand coils 38 and 39 are wound circularly with diameter d₃, and the third circular magnetic strip 50 has a diameter d₃ᵣ that is greater than d₃. The coils are disposed inside the rotors. In the illustrated embodiment, d₁ is substantially equal to d₂, which is substantially equal to d₃; likewise, d₁ᵣ is substantially equal to d₂ᵣ, which is substantially equal to d₃ᵣ.

In one embodiment, each of these magnetic strips 50, 56 and 76 has forty-five N/S pairs of magnetic poles, corresponding to forty-five stator fingers contained in each of four circular rows in each of the stators 32, 58 and 78. The magnetic poles in the magnetic strips 50, 56 and 76 are attracted to the magnetic field surrounding the respective coils 38 and 39, 60 and 62, and 80 and 82 when a current is present therein resulting in the rotation of the rotors 16, 22 and 30, which results in the rotation of the hour, minute and second hands. The independent motion of each allows for different rotation rates based on field.

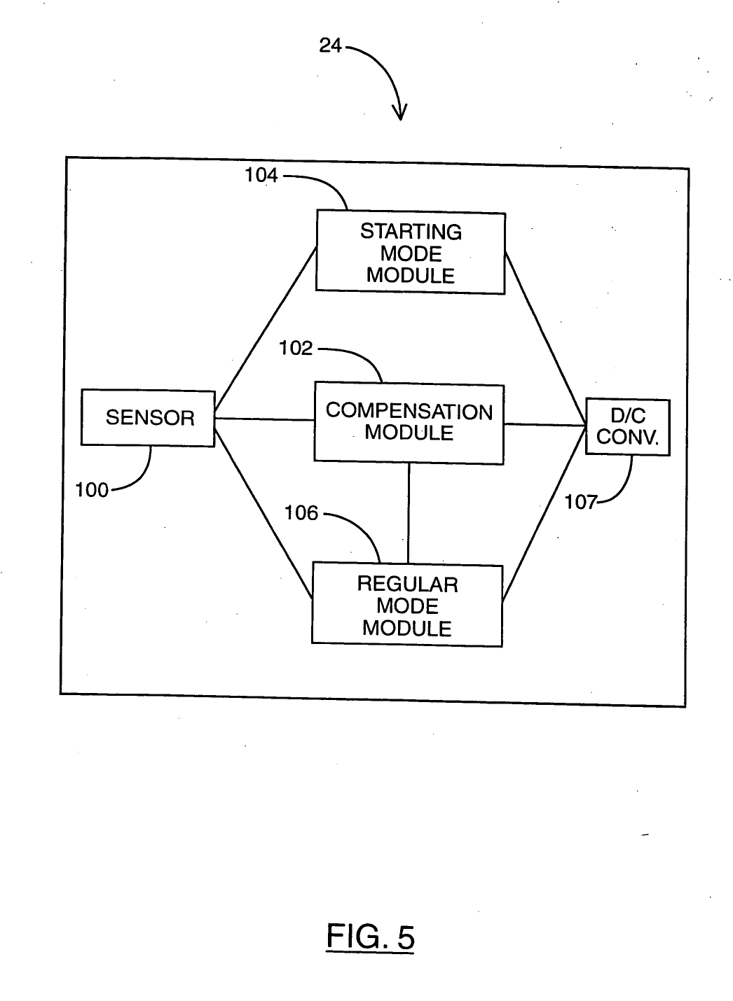

FIG. 5 shows the controller 24 of the clock 10 of FIG. 1. The controller 24 includes a sensor 100, a compensation module 102, a starting mode module 104, a regular mode module 106 and a digital-to-analog converter 107.

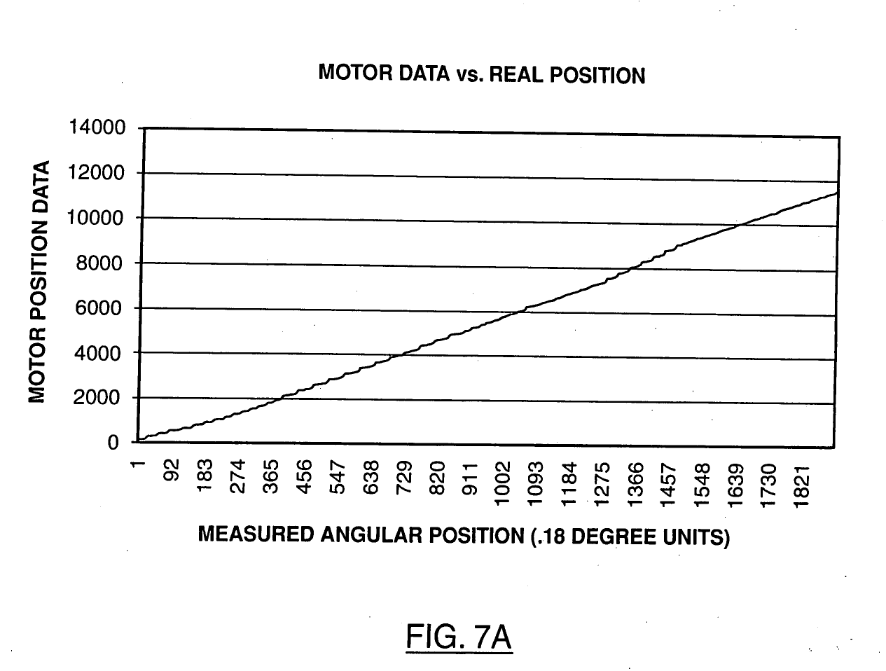

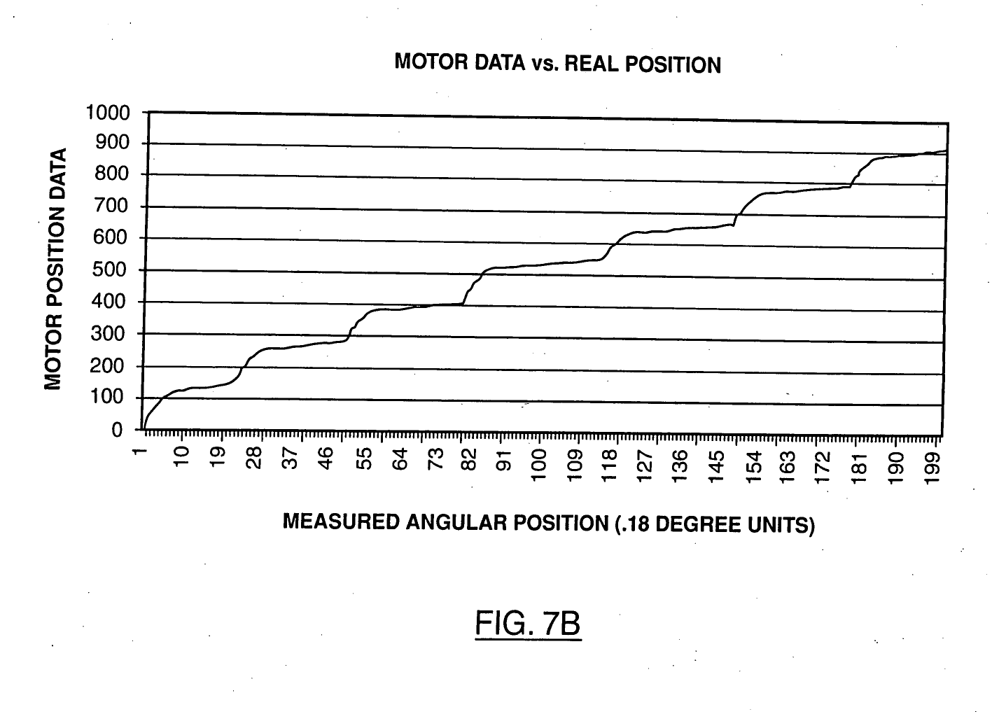

As illustrated in FIG. 7, the controller 24 controls the motion of the stepper motors 14, 20 and 28 by using a digital-to-analog converter 107, such as an 8-bit converter. The digital-to-analog converter 107 converts digital signals from the compensation module 102, the starting mode module 104 and the regular mode module 106, which are described below, into analog signals to drive the stepper motors 14, 20 and 28. The analog signals driving the first stepper motor 14 can be sinusoidal voltage signals, a first voltage signal directed to the hour-hand coil 60 and a second voltage signal, with a ninety-degree phase shift from the first signal, directed to the hour hand coil 62. The two other stepper motors 20 and 28 can be similarly controlled.

There are 45 pole pairs around the clock in both the rotating permanent magnet 49, and, in the presence of a current, in the fixed stators 38 and 39. It should be noted that the two sets of stators are offset or rotated, by half a pole about the common axis. When current is fed through one of the coils disposed within one stator pair, this pair will generate a magnetic field around the outside of it comprising of 45 north/south pairs. Since opposite magnetic poles are attracted to each other, the rotating permanent magnet will rotate to a position so that its 45 south poles are closest to the stators 45 north poles, and the permanent magnets 45 north poles are closest to the stators 45 south poles.

If the current in the above-mentioned coil is stopped, and current is put into the other coil, the magnetic field around the stator pairs will now be moved, or rotated, by half a pole. This will cause the rotating permanent magnet to rotate slightly to align its poles as mentioned above. This will have caused a rotation of a pole pair, or 1/180 of a rotation.

The next step is to remove the current in the second coil, and apply it to the first coil in the opposite direction. This will cause the second coil to have its north/south poles in a reversed position to before. This in turn, causes the rotating permanent magnet to rotate by another pole pair.

The next step is to remove the current in the first coil, and apply it to the second coil in the opposite direction. This will cause the second coil to have its north/south poles in a reversed position to before. This in turn, causes the rotating permanent magnet to rotate by another pole pair.

The last step is to remove the current in the second coil, and put the current back in the first coil in the same direction that this process started. This in turn causes the rotating permanent magnet to rotate by another pole pair. At this point, the rotating permanent magnet has rotated one complete pole pair. By repeating this process, the rotating magnet can be continuously rotated about the common axis.

While the above describes four positions per rotation, it is possible to apply half the current to one coil and half the current to the other coil. This would cause the rotating permanent magnet to move to a position halfway between the positions that it would have had if the current had been applied to only one coil or the other. This can be extended to any fraction of currents. The position of the rotating permanent magnet is proportional to the relative currents in the coils.

By varying the current in each of the coils, the rotating permanent magnet can be put to any of a plurality of positions. The circuitry controlling the current in the coils has 256 different levels of current. By using this method, the rotating permanent magnet and its associated rotor and shaft and hand can be rotated through 256 steps per pole pair, or 11520 steps total.

The sensor 100 includes hardware and/or software that senses the position of the hour hand 12, the minute hand 18 and the second hand 26. The sensor 100, for example, can include an opto-interrupter, known to those of ordinary skill, which is used to determine the position of the hands. In particular, as the hour hand 12 and the first flange 54 rotate rigidly together, and as the first flange 54 passes the opto-interrupter, a light beam in the opto-interuptor is blocked by the first flange 54 sending a signal to the controller 24. Thus, the controller 24 can ascertain the position of the hour hand 12, and similarly the positions of the minute hand 18 and the second hand 26. If a signal is obtained anywhere within a pole pair, the exact position can be ascertained to one step out of the 11520 available.

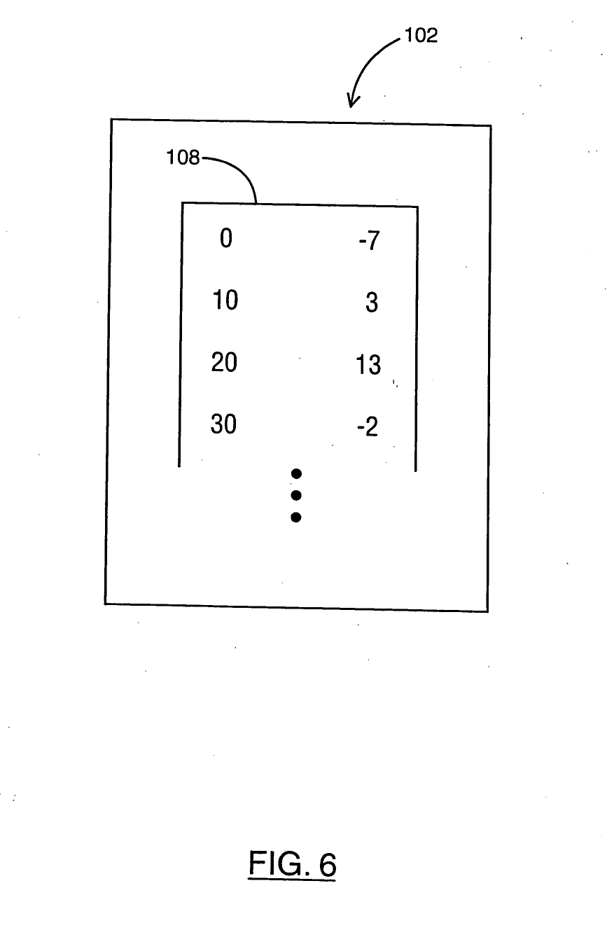

The compensation module 102 tests the third stepper motor 28 for discrepancies between the expected behavior of the motor and the actual behavior, such as may arise from non-linearities in the motor. The compensation module 102 then establishes a compensation table 108, as shown in FIG. 6, to correct these types of discrepancies, as described in more detail below.

The starting mode module 104 includes hardware and/or software for setting the time when the clock 10 is powered on for the first time, or powered on after regular power has been interrupted.

The regular mode module 106 is responsible for maintaining the correct time during regular operation of the clock 10. In particular, during the regular operation of the clock 10, the controller 24 sends digital signals to the digital to analog converter 107, which in turn varies the voltage of the coils 38, 39, 60, 62, and 80, 82. By varying the voltage, the magnetic field generated by the coils also varies and attracts the magnetic strip in the rotors, thereby stepping the hands 12, 26 and of the clock 10.

FIG. 6 shows the compensation module 102 of the controller 24. The compensation module 102 includes a compensation table 108, as determined by the controller 24, which is used to correct discrepancies in the stepper motors 14, 20 and 28.

In particular, because tolerances used at the point of manufacture may be too liberal, the stepping of the motor can lead to some error that is manifested by jerky motion of the second hand of the clock. These errors can also cause the second hand to not stop exactly over the second ticks printed on the face of the clock.

Two plots demonstrating these errors appear in FIG. 7A and 7B. FIG. 7A shows the third stepper motor 28 data that is sent to the drive of the motor (labeled “motor position data”) vs. actual measured position of the second hand over 360 degrees (labeled “measured angular position”). FIG. 7B is a magnification of a region of FIG. 7A to show the detail for that region. The undulations in these two plots are indicative of the less than ideal operation of the third stepper motor 28, namely the one for the second hand of the clock 10. In effect, the compensation module 102 corrects the data, as described below, so that a resultant plot of the same variables would yield almost straight lines.

In particular, to correct these errors associated with these undulations, a compensation table 108 can be constructed. The construction of the compensation table 108 is typically performed just once when the clock is manufactured, although new tables could be updated or constructed whenever appropriate.

To construct the table 108, the second hand 26 is slowly rotated. When the second hand is at a particular interruption position (e.g., the 9:00 o'clock position), as determined by an opto-interrupter, the controller 24 starts reading data indicating the subsequent actual angular position of the second hand 26. This data is fed to a computer via a serial port. After the second hand 26 has rotated five times, which takes about 10 minutes, the computer has enough actual angular position data. This data is used to construct the compensation table 108 by tabulating the actual angular position data with the corresponding step of the stepper motor 28 (i.e., the motor position data of the plots in FIGS. 7). Thus, the motor is rotated slowly when measuring the actual position of the motor because the motor is set to a particular position, and then allowed to settle. If the rotation were too fast, the inertia would smooth out all of the irregularities in the system, and no useful data would be obtained. Five rotations allows better data accuracy by averaging the data, and if necessary ignoring any obviously incorrect data points

The compensation table 108 enables the controller 24 to apply a correction at each position of the third stepper motor 28. Specifically, when the clock is running normally, it maintains a position of each hand as a number from 0 to 11519 representing 360 degrees. This represents 11520 steps per rotation, which equals 45 pole pairs ×256 (the last number corresponding to an 8-bit D/C converter). The table associates a position with a compensation correction from −128 to +127. In one embodiment, the table 108 has a compensation correction for each of the 11520 positions. In another preferred embodiment, fewer corrections are supplied, and interpolation used to allow the controller 24 to obtain a correction at all the positions.

As an example of how the table 108 is used, when the clock 10 is at 30 seconds past the minute, the controller 24 calculates that the position should be 5760. The controller 24 then consults the table and finds (explicitly or by interpolation) that the position 5760 is associated with the correction −12. The controller 24 consequently positions the hand at 5748.

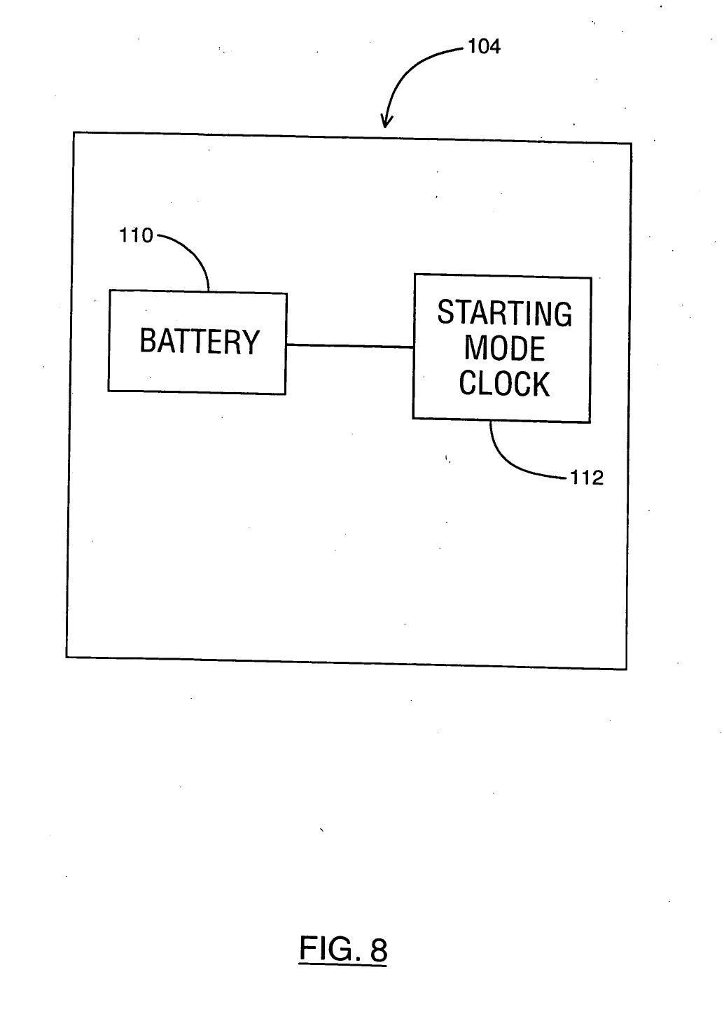

FIG. 8 shows the starting mode module 104 of the controller of FIG. 5. The starting mode module 104 includes a battery 110 and a starting mode clock 112.

The starting mode module 104 sets the time when the clock 10 is powered on for the first time, or after regular power has been interrupted. When the clock 10 is powered on, the starting mode module 104 reads the time from the starting mode clock 112, which is powered by the battery 110, and subsequently moves the hands 12, 18 and 26 to the interruption position, e.g., nine o'clock. Next, the hands of the clock 10 are moved to the correct position based on the time read from the starting mode clock 112.

The starting mode module 104 invokes this time-setting procedure whenever the clock 10 is powered on, such as when the clock 10 is started for the first time, or after regular power has been cut because of a power failure. In the latter case, a battery 110 can be provided to provide power for the operation of the clock 10 until regular power resumes.

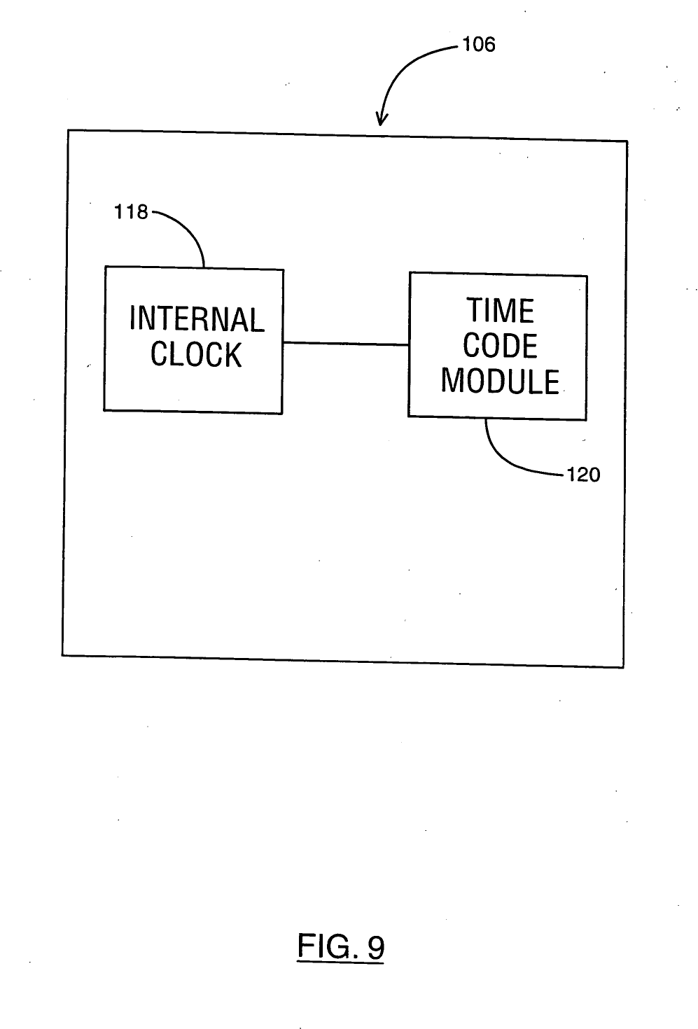

FIG. 9 shows the regular mode module 106 of the controller 24 shown in FIG. 5. The regular mode module 106 includes an internal clock 118 and a time code module 120.

The internal clock 118, known to those of ordinary skill, is the master clock that governs the motion of the hands 12, 18 and 26 during regular operation of the clock 10. In addition, the internal clock 118 is used to update the starting mode clock 112 every minute to keep the clock 112 current in case it is needed.

The time code module 120 reads time from an industry standard input signal called Linear Time Code (LTC) or a European time code signal called EBU, as known to those of ordinary skill. This signal is then used to update the internal clock 118. Many methods are possible to feed this signal into the clock 10, including connecting the clock 10 to a personal computer via a communication line. The hardware providing-this signal and the type of connection is myriad and known to those of ordinary skill. For example, the source of this signal can be the Internet or a satellite.

The internal clock 118 can also be changed without an industry standard input signal by, for example, connecting the clock 10 to a computer and providing appropriate computer instructions, or by push-button and/or toggle switches (not illustrated) on the clock 10 that allow someone to manually set the time.

The clock 10 can operate on regular power provided by an electrical outlet. Additionally, the clock 10 can be linked to a second clock, so that only one of them requires external power to operate. Power is transferred through the link as well as the programming signal, if any.

It should be understood that various modifications could be made to the embodiments described and illustrated herein, without departing from the present invention. For example, although the compensation table 108 has been described in connection with the second hand 26, a compensation table could also be used to correct the positions of the minute hand 18 and the hour hand 12. The scope of the present invention is defined in the following claims.

1. A clock comprising
an hour hand;
a first stepper motor having a first rotor for rotating the hour hand, the first rotor being rigidly connected to the hour hand;
a minute hand;
a second stepper motor having a second rotor for rotating the minute hand, the second rotor being rigidly connected to the minute hand; and
a controller for controlling the first stepper motor and the second stepper motor.

2. The clock of claim 1, wherein the hour hand and the minute hand can be rotated independently with appropriate controller instructions.

3. The clock of claim 1, further comprising
a second hand; and
a third stepper motor having a third rotor for rotating the second hand, the third rotor being rigidly connected to the second hand.

4. The clock of claim 3, wherein the hour hand, the minute hand, and the second hand can be rotated independently with appropriate controller instructions.

5. The clock of claim 4, wherein the first rotor is rigidly connected to the hour hand via a first shaft, the second rotor is rigidly connected to the minute hand via a second shaft and the second hand is rigidly connected to the third rotor via a third shaft.

6. The clock of claim 5 wherein at least two of the first shaft, the second shaft and the third shaft are hollow, and wherein the first shaft, the second shaft and the third shaft are concentrically nested.

7. The clock of claim 6, wherein the second shaft is hollow and the first shaft is hollow, and wherein the third shaft is disposed within the second shaft, which is disposed within the first shaft.

8. The clock of claim 7, wherein the first shaft, the second shaft and the third shaft are cylindrical with a common axis.

9. The clock of claim 8, wherein the first stepper motor includes a first stator having two hour-hand coils wound about the common axis, the second stepper motor includes a second stator having two minute-hand coils wound about the common axis, and the third stepper motor includes a third stator having two second-hand coils wound about the common axis.

10. The clock of claim 9, wherein the hour-hand coils are stacked on top of the minute-hand coils which are stacked on top of the second-hand coils.

11. The clock of claim 10, wherein the first rotor, the second rotor and the third rotor rotate about the common axis.

12. The clock of claim 11, wherein the first rotor is stacked on top of the second rotor which is stacked on top of the third rotor.

13. The clock of claim 12, wherein the first rotor includes a first permanent magnet disposed on the inner perimeter of the first rotor, the second rotor includes a second permanent magnet disposed on the inner perimeter of the second rotor, and the third rotor includes a third permanent magnet disposed on the inner perimeter of the third rotor.

14. The clock of claim 13, wherein each of the first permanent magnet, the second permanent magnet and the third permanent magnet has ninety magnetic poles.

15. The clock of claim 14, wherein
a) the two hour-hand coils are wound circularly with diameter d₁, and the first permanent magnet is a first circular magnetic strip with diameter greater than d₁;
b) the two minute-hand coils are wound circularly with diameter d₂, and the second permanent magnet is a second circular magnetic strip with diameter greater than d₂; and
c) the two second-hand coils are wound circularly with diameter d₃, and the third permanent magnet is a third circular magnetic strip with diameter greater than d₃.

16. The clock of claim 15, wherein the controller includes an 8-bit digital to analog converter for producing an analog signal to control the first stepper motor, the second stepper motor and the third stepper motor.

17. The clock of claim 16, wherein each of the first step motor, the second step motor and the third step motor can be stepped 192 times or more per second.

18. A clock comprising
an hour hand;
a first stepper motor for rotating the hour hand, the first stepper motor having a coil wound about an axis and a rotor that rotates about the axis;
a minute hand;
a second stepper motor for rotating the minute hand; and
a controller for controlling the first stepper motor and the second stepper motor, wherein the coil is disposed inside the rotor.

19. The clock of claim 18, wherein the hour hand and the minute hand can be rotated independently with appropriate controller instructions.

20. A clock comprising
an hour hand, a minute hand and a second hand;
a first stepper motor, a second stepper motor and a third stepper motor for stepping the hour hand, the minute hand and the second hand, respectively;
a controller for controlling the first stepper motor, the second stepper motor and the third stepper motor; and
a compensation table including two sets of data, the first set having position data of the second hand, and the second set having associated position correction data of the second hand, wherein the controller uses the compensation table for correcting errors in the stepping of the third stepper motor.

21. The clock of claim 20, further comprising a second compensation table used by the controller for correcting errors in the stepping of the second stepper motor.

22. The clock of claim 20, wherein the clock can be linked to a second clock, so that only one of them requires external power to operate.

23. A method for rotating the hands of a clock, the method comprising
rotating an hour hand of the clock with a first rotor of a first stepper motor, the first rotor being rigidly connected to the hour hand;
rotating a minute hand of the clock with a second rotor of a second stepper motor, the second rotor being rigidly connected to the minute hand; and
controlling the first stepper motor and the second stepper motor with a controller.

24. The method of claim 23, wherein the hour hand and the minute hand can be rotated independently with appropriate controller instructions.

25. The method of claim 23, further comprising rotating a second hand of the clock with a third rotor of a third stepper motor, the third rotor being rigidly connected to the second hand.

26. The method of claim 25, wherein the hour hand, the minute hand, and the second hand can be rotated independently with appropriate controller instructions.

27. The method of claim 26, wherein the first rotor is rigidly connected to the hour hand via a first shaft, the second rotor is rigidly connected to the minute hand via a second shaft and the second hand is rigidly connected to the third rotor via a third shaft.

28. The method of claim 27 wherein at least two of the first shaft, the second shaft and the third shaft are hollow, and wherein the first shaft, the second shaft and the third shaft are concentrically nested.

29. The method of claim 28, wherein the second shaft is hollow and the first shaft is hollow, and wherein the third shaft is disposed within the second shaft which is disposed within the first shaft.

30. The method of claim 29, wherein the first shaft, the second shaft and the third shaft are cylindrical with a common axis.

31. The method of claim 23, wherein the controller includes an 8-bit digital to analog converter for producing an analog signal to control the first stepper motor, the second stepper motor and the third stepper motor.

32. The method of claim 23, wherein each of the first step motor, the second step motor and the third step motor can be stepped 192 times or more per second.

33. A method for manufacturing a clock, the method comprising
providing a first stepper motor for rotating the hour hand, the first stepper motor having a coil wound about an axis and a rotor that rotates about the axis;
providing a second stepper motor for rotating the minute hand; and
providing a controller for controlling the first stepper motor and the second stepper motor, wherein the coil is disposed inside the rotor.

34. The method of claim 33, wherein the hour hand and the minute hand can be rotated independently with appropriate controller instructions.

35. A method of correcting errors in a clock, the method comprising
stepping an hour hand, a minute hand and a second hand with a first stepper motor, a second stepper motor and a third stepper motor, respectively; and
correcting errors in the stepping of the third stepper motor with a compensation table that includes two sets of data, the first set having position data of the second hand, and the second set having associated position correction data of the second hand.
